(19) United States
(12) Patent Application Publication
(10) Pub. No.: US 2026/0225816 A1
(43) Pub. Date: Aug. 6, 2026

(54) NON-TENTING CONVEYOR BELT

(71) Applicant: Laitram, L.L.C., Harahan, LA (US)

(72) Inventors: David W. Bogle, Franklinton, LA (US); John M. Arnold, Jr., Metairie, LA (US); Kyle J. Sedlacek, New Orleans, LA (US); Henry H. Gilley, Jr., Slidell, LA (US); Robert Guttenberg, River Ridge, LA (US)

(21) Appl. No.: 19/151,754

(22) PCT Filed: Feb. 1, 2024
(86) PCT No.: PCT/US2024/013942

§ 371 Date: Jul. 29, 2025

Related U.S. Application Data
(60) Provisional application No. 63/444,760, filed on Feb. 10, 2023.

(51) Int. Cl. B65G 17/08

(52) U.S. Cl. CPC B65G 17/083

(57) ABSTRACT

A metal modular conveyor belt having hinge rods with noncircular portions to prevent the belt from tenting at collapsed belt edges at the inside of a turn. The noncircular portions of the hinge rods received in rod holes through tension links maintain the tension links in a planar relationship, which prevents tenting.

### BACKGROUND

The invention relates generally to power-driven conveyors and more particularly to modular metal conveyor belts especially suitable for use in spiral conveyors.

One example of a conveyor belt suitable for use in a spiral conveyor system is shown in FIG. 7. The belt 20 comprises a series of belt rows 22 joined by hinge rods 24 having a circular cross section. Each row 22 has U-shaped tension links 26 at laterally opposite sides of the belt 20. An interior wire mesh 28 between the tension links 26 supports conveyed articles. Drive lugs 30 capping the hinge rods 24 radially outward of the side of the belt 20 are positively engaged by regularly spaced vertical drive members on the periphery of a spiral drive drum (not shown).

The inside edge of the belt 20 engaged with the spiral drive drum collapses because it is radially inward of the outside edge of the belt. The tension links 26 at the outside edge bear the belt tension, while the tension links at the collapsed inside edge bear no tension. Any interruption, e.g., a bump or a change in friction, along the carryway supporting the belt 20 can cause a portion of the belt at the collapsed inside portion to pop up. The popped-up portion 32 resembles a tent, and the popping up of belt portions is referred to as tenting. The outside edge, which is in tension, remains in plane and does not tent. Because there are no forces to push the tented portion 32 down, the tented portion persists until the belt 20 exits the spiral and starts to run straight with the tension links at both sides of the belt expanded and sharing the belt tension. And tenting can involve multiple rows forming each roof panel of a tall tent. Tenting can cause a belt to jam if the tent is tall enough to contact spiral support structure supporting the spiral tier above or if the tent encounters belt-edge holddowns in a descending spiral system. Tenting can even damage conveyed products in some cases. Tenting can occur in friction-driven spiral belts and in side-driven spiral belts, as well as in direct-drive spiral belts as shown in FIG. 7.

### SUMMARY

A conveyor belt embodying features of the invention comprises a plurality of belt rows extending in width from a first side to a second side and along a conveying direction from a first end to a second end. Each belt row includes a first tension link at the first side, a second tension link at the second side, and an article-supporting section between them. The first and second tension links have a first rod hole at the first end and a second rod hole at the second end. The article-supporting section between the first and second tension links extends from the first end to the second end of the belt row. The second rod holes of the first and second tension links of each belt row are aligned with the first rod holes of the first and second tension links of an adjacent belt row. Hinge rods extend through the aligned first and second rod holes and the first and second ends of the article-supporting sections of the adjacent belt rows to join the belt rows together at hinge joints between adjacent belt rows.

At least some of the hinge rods have a noncircular portion received in the first or second rod holes of the first tension links and shaped relative to the shape of the first or second rod holes to maintain the belt rows planar to prevent tenting.

### BRIEF DESCRIPTION OF THE DRAWINGS

FIG. 1 is an axonometric view of one side of a portion of a conveyor belt embodying features of the invention.

FIG. 2 is a top plan view of the side of the conveyor belt of FIG. 1.

FIGS. 3A and 3B are two views of a rod end cap for the conveyor belt of FIG. 1.

FIG. 4 is an axonometric view of a tension link and hinge rod in another version of a conveyor belt.

FIG. 5 is another view of the tension link and hinge rod of FIG. 4 showing a cross section of a swaged portion of the hinge rod.

FIG. 6 is an axonometric view of one side of another version of a conveyor belt embodying features of the invention.

FIG. 7 is an axonometric view of a conveyor belt tenting.

### DETAILED DESCRIPTION

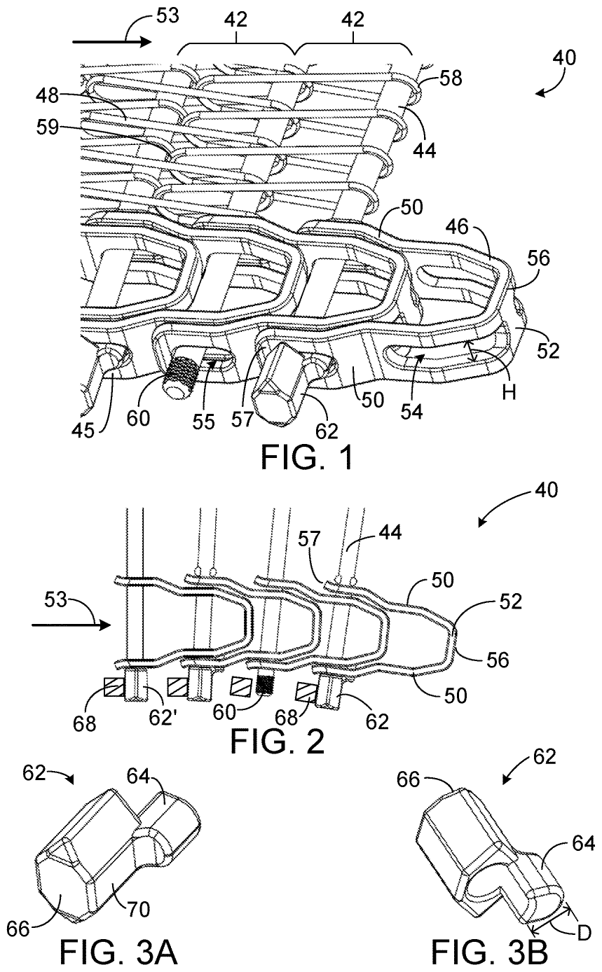

One side of one version of a side-flexing metal conveyor belt suitable for use in a spiral conveyor is shown in FIGS. 1 and 2. The belt 40 is constructed of a series of belt rows 42 connected end to end by hinge rods 44 at hinge joints. Each belt row 42 extends in width from a first side 45 to an opposite second side and along a conveying direction 53 from a first end 56 to a second end 57. Each row 42 has a tension link 46 at each side and an intermediate article-supporting section 48 between the tension links 46 at opposite sides of the row. The article-supporting section 48 of each belt row 42 in this example is a wire mesh wound helically around hinge rods 44 at the ends of each row. The tension links 46 in this example are U-shaped links having a pair of arms 50 extending from a base 52. But single-armed tension links can alternatively be used.

Each arm 50 of the U-shaped tension links 46 has a first rod hole 54 at the first end 56 of the belt row 42 and a second rod hole 55 at the second end 57. The first rod holes 54 of the tension links 46 of each belt row 42 are aligned with the second rod holes 55 of an adjacent belt row. The hinge rods 44 extend through the aligned first and second rod holes 54, 55 and first and second ends 58, 59 of the article-supporting section 48. The first rod holes 54 are slots elongated in the conveying direction 53 partway along the arms 50 to the base 52. The second rod holes 55 are also elongated slots nearer the second ends 57 of the arms 50. The second slotted rod holes 55 are shorter than the first rod holes 54. The elongated rod holes 54, 55 allow the first side 45 of the belt 40 to collapse at the inside of a turn, such as around the periphery of a spiral drive drum.

Each of the otherwise circular hinge rods 44 has a knurled end 60 onto which an end cap 62, 62 is pressed. (In the drawing, an end cap 62 is not shown on one of the hinge rods 44 to reveal its knurled end.) The end caps 62, as also shown in more detail in FIGS. 3A and 3B, head the hinge rods 44 outside the sides of the belt 40. A noncircular portion 64 of the end cap 62 is received in the outermost second rod holes 55. The noncircular portion 64 could instead or also extend through the aligned first rod hole 54 of the adjacent row 42. Or the noncircular portion could be elongated laterally to extend through one or both of the aligned rod holes in the inner arm of the tension links. The noncircular portion 64 has a maximum diameter D that exceeds the height H of the slotted rod holes 54, 55 to prevent the collapsed first side 45 of the belt row 42 from rising out of its planar relationship with the tensioned other side of the belt row and causing tenting.

The end cap 62 also has a driving portion in the form of a drive lug 66 that is outside the side 45 of the belt 40. The drive lugs 66 are suitable for positively engaging drive bars 68 on the periphery of a rotating spiral drive drum. The drive bars 68 push against drive faces 70 on the end caps 62 to advance the conveyor belt 40 on a helical path around the spiral drive drum. Although the end caps 62 with anti-tenting noncircular portions 64 could cap every hinge rod 44, they could alternatively be installed only on every other hinge rod. In that case, the other half of the hinge rods 44 could be capped with drive lugs 62′ that lack the anti-tenting noncircular portion 64. Although not shown, the second side of the belt 40 could have the same end caps 62, 62′ as the first side 45. But if only the first side 45 of the belt 40 is to be driven at the inside on turns, drive lugs 62, 62′ are not necessary on the other side at the outside of turns, and the ends of the hinge rods at the second side of the belt rows could be welded to the tension links or otherwise fastened or retained.

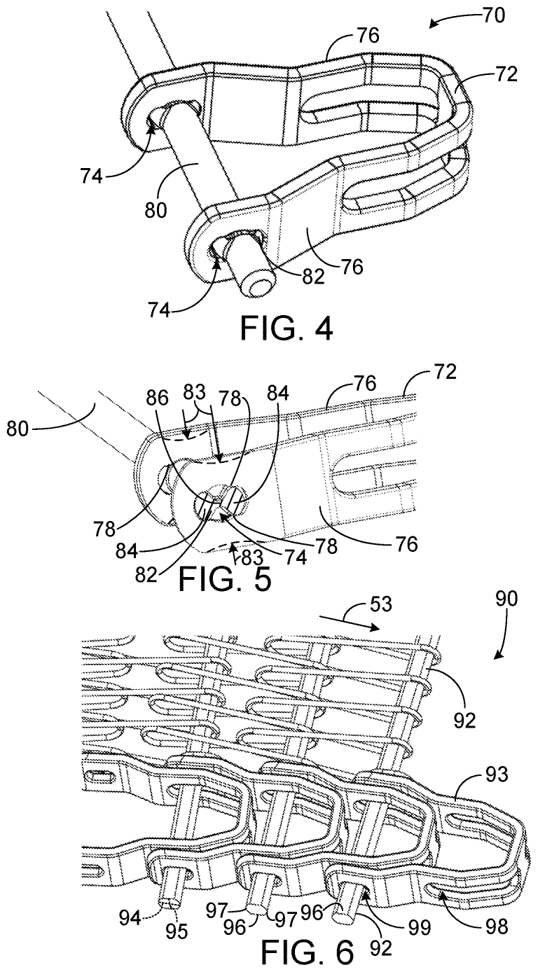

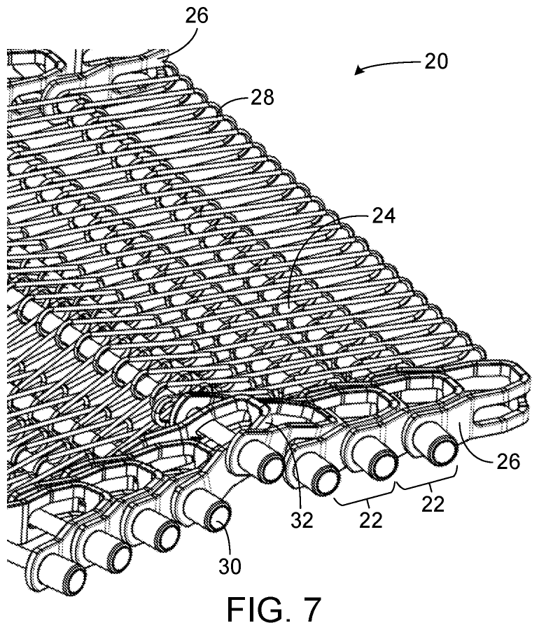

Another version of an anti-tenting feature for a metal-link conveyor belt is shown in FIGS. 4 and 5. In this version the tension link 72 has second rod holes 74 in each arm 76 that are bounded by walls with detents 78. The otherwise circular hinge rods 80 are swaged to form noncircular portions 82 that are received in the second rod holes 74. The noncircular portions can alternatively be formed by grinding or machining the hinge rods. The noncircular portions 82 are characterized by two lobes 84 joined by a narrow neck 86. The detents 78 retain the lobes 84 and maintain the tension links 72 and their belt rows in their planar relationship in contact with supporting conveyor structure below to prevent tenting. The noncircular portions 82 of the hinge rods 80 can be further prevented from rotating in the second rod holes 74. Compressing the arms 76 above and below as indicated by arrows 83 deforms the arms and narrows the second rod holes 74 around the hinge rods 80 to limit their axial and rotational movement relative to the tension link 72.

FIG. 6 shows another version of a non-tenting metal conveyor belt 90. The belt 90 is similar to the belt 40 of FIG. 1 but differs in that it uses a noncircular hinge rod 92 that has a major axis 94 and a shorter minor axis 95. The major axis 94 extends along the conveying direction 53. And, in this example, the hinge rod 92 has flats 96 between rounded ends 97.

Tension links 93 have first and second rod holes 98, 99 in each arm. The hinge rod's minor axis 95 is slightly shorter than the height of the first or second elongated rod hole 98, 99. The major axis 94 is longer than the height of the first or second rod hole 99. Thus, the tension links 93 are retained in their planar relationship, which prevents the belt 90 from tenting. Although the entire length of the hinge rod 92 is shown with the same noncircular shape, only the portion of the rod that is received in the first or second rod holes 98, 99 has to be noncircular; the rest of the hinge rod could be circular or some other shape. And the arms of the tension links 93 can optionally be deformed above and below the second rod holes 99 as in FIG. 5 to help limit movement of the hinge rods 92.

Although the invention has been described in detail with respect to direct-driven spiral belts with drive lugs, the anti-tenting features formed by noncircular portions on hinge rods preventing no significant rotation of the hinge rods in the tension links could be applied to side-driven spiral belts with drive-receiving structure at one or both sides or to friction-driven spiral belts without drive lugs engaging the spiral drive drum. And, as used in the claims in the phrase “the first or second rod holes,” “or” is defined as the “inclusive or.”

What is claimed is:

1. A conveyor belt configured to advance in a conveying direction, the conveyor belt comprising:
a plurality of belt rows extending in width from a first side to a second side and along a conveying direction from a first end to a second end, each belt row including:
a first tension link at the first side and having a first rod hole at the first end and a second rod hole at the second end;
a second tension link at the second side and having a first rod hole at the first end and a second rod hole at the second end;
an article-supporting section between the first and second tension links and extending from the first end to the second end of the belt row;
a plurality of hinge rods;
wherein the second rod holes of the first and second tension links of each belt row are aligned with the first rod holes of the first and second tension links of an adjacent belt row and wherein the hinge rods extend through the aligned first and second rod holes and the first and second ends of the article-supporting sections of the adjacent belt rows to join the belt rows together at hinge joints between adjacent belt rows;
wherein at least some of the hinge rods have a noncircular portion received in the first or second rod holes of the first tension links and shaped relative to the shape of the first or second rod holes to maintain the belt rows planar to prevent tenting.

2. The conveyor belt as claimed in claim 1 wherein all the hinge rods have noncircular portions received in the first or second rod holes of the first tension links and shaped relative to the shape of the first or second rod holes to prevent tenting between adjacent belt rows.

3. The conveyor belt as claimed in claim 1 wherein the noncircular portion extends the full length of the hinge rods.

4. The conveyor belt as claimed in claim 1 wherein the noncircular portion has flats between rounded ends.

5. The conveyor belt as claimed in claim 1 wherein the noncircular portion has a cross section with a major axis and a minor axis.

6. The conveyor belt as claimed in claim 5 wherein the major axis is along the conveying direction.

7. The conveyor belt as claimed in claim 1 wherein at least some of the hinge rods include end caps heading the hinge rods and wherein the noncircular portion received in the second rod holes of the first tension links is formed on the end caps.

8. The conveyor belt as claimed in claim 7 wherein the end caps include a drive lug outside the first side of the belt rows.

9. The conveyor belt as claimed in claim 1 wherein the rod holes are elongated in the conveying direction and have a height and wherein the noncircular portions of the hinge rods have a maximum diameter that exceeds the height of the rod holes.

10. The conveyor belt as claimed in claim 1 wherein the noncircular portions are formed by swaging, grinding, or machining the hinge rods.

11. The conveyor belt as claimed in claim 10 wherein the noncircular portions have a cross section characterized by two lobes and wherein the rod holes are bounded by walls having detents that block the lobes and prevent rotation of the hinge rods in the rod holes.

12. The conveyor belt as claimed in claim 1 wherein the first tension links in which hinge rods with noncircular portions are received in the second rod holes are compressed above and below the hinge rods to deform the second rod holes around the hinge rods.

13. The conveyor belt as claimed in claim 1 wherein all the hinge rods have noncircular portions received in the first or second rod holes of the first and second tension links and wherein the hinge rods are shaped relative to the shape of the first or second rod holes to prevent tenting between adjacent belt rows.

14. The conveyor belt as claimed in claim 1 wherein the noncircular portions of the hinge rods received in the first or second rod holes of the first tension links extend through the aligned second or first rod holes of the first tension links of an adjacent belt row.

15. The conveyor belt as claimed in claim 1 wherein the first and second tension links are U-shaped with two arms and wherein each of the arms has one first rod hole and one second rod hole.

16. The conveyor belt as claimed in claim 15 wherein the noncircular portions of the hinge rods extend through the first and second rods holes in both arms of the first or second tension links.

17. The conveyor belt as claimed in claim 1 wherein at least every other one of the hinge rods has a noncircular portion received in the first or second rod holes of the first tension links and shaped relative to the shape of the first or second rod holes to maintain the belt rows planar to prevent tenting.
